(19) United States
(12) Patent Application Publication
(10) Pub. No.: US 2007/0032999 A1
(43) Pub. Date: Feb. 8, 2007

(54) System and method for emulating hardware failures and method of testing system software incorporating the same

(75) Inventors: Eric J. Bauer, Freehold, NJ (US); Bradford G. Van Treuren, Lambertville, NJ (US)

Correspondence Address: HITT GAINES, PC;LUCENT TECHNOLOGIES INC., PO BOX 832570, RICHARDSON, TX, 75083, US

(73) Assignee: Lucent Technologies Inc., Murray Hill, NJ (US)

(21) Appl. No.: 11/198,119

(22) Filed: Aug. 5, 2005

(51) Int. Cl. G06F 9/455

(52) U.S. Cl. 703/23

(57) ABSTRACT

A system for, and method of, emulating hardware failures and a Joint Test Action Group (JTAG) test tool incorporating the same. In one embodiment, the system includes: (1) a vector generator configured to generate at least one device failure emulation vector and (2) a JTAG interface associable with the vector generator and configured to deliver the device failure emulation vector to hardware thereby to test system software associated with the hardware.

### TECHNICAL FIELD OF THE INVENTION

The present invention is directed, in general, to system software testing and debugging and, more specifically, to a system and method for emulating hardware failures and method of testing system software incorporating the same.

### BACKGROUND OF THE INVENTION

Many of today's sophisticated electronic systems are embodied in a combination of hardware and “system software” for controlling the hardware. Such systems, which will be called “combination systems” for purposes of the present discussion, combine the speed and power that task-specific, or “dedicated,” hardware offers and the flexibility and ease of development that system software affords.

For this reason, such systems are used in a wide variety of applications. One specific application is an Asynchronous Transfer Mode (ATM) switch, used in telecommunications networks. An ATM switch typically uses dedicated hardware to provide a switching matrix, or “fabric,” to interconnect endpoints and controls that hardware by means of sophisticated switch management system software. Although just one example, an ATM switch does require what many applications also require: the need for extremely high availability.

“High Availability System software” for a highly reliable system must be tested where most if not all error conditions can be automatically detected so recovery from the failure can occur prior to system failure or with the shortest duration of down time allowable. To this end, system engineers have developed several techniques for emulating hardware failures with which the system software must contend.

One technique is to power-down certain devices in the hardware using dedicated circuitry. Unfortunately, this requires that the dedicated circuitry be added to isolate the power bus from the certain device. It also adds cost to the development of the combination system, since more design elements are required. A greater likelihood also exists that the hardware may fail, since the complexity of its design is greater.

Another technique is to power down the device using an additional switch on the power lead. However, this requires circuit traces to be cut and switches installed to physically disconnect the power bus from the device. As before, a reworked board is less reliable over the long term. Further, circuit board physical design frequently does not support the mechanical support for fault switch. Such circuit boards are often not designed to be robust for heavy use.

Yet another technique is to hold the device in a reset mode using dedicated circuitry. Unfortunately, this requires special circuits be added to restrict the temporary reset operation to a single device. It adds cost to the hardware, since more design elements are required. The likelihood of failure increases since the complexity of the design is greater.

Still another technique is to hold the device in a reset mode with a white-wire pull-down change. However, this requires the cutting of the reset trace in the hardware to be able to add a white wire change to pull the device pin to the reset value. As a result, the circuit board is no longer usable for production testing. Furthermore, the system software cannot be brought to a normal functional state during boot operation, since the device is permanently reset.

Another technique is to leave the device off the board, or “de-populate” the device. Unfortunately, this requires the hardware to be reworked to remove the device or a special assembly in which the device is not populated in the first place. As above, the system software cannot be brought to a normal functional state during a boot operation, since the device does not physically exist.

Yet another technique is to cut circuit traces from device outputs. This is sometimes called a “failable pack.” However, this requires modifying existing functional hardware physically to disconnect the signal from a device pin. The system software cannot be brought to a normal functional state during a boot operation, since the device outputs no longer connect to mating circuits.

Still another technique is to place switches at circuit outputs. This is also a type of “failable pack.” Unfortunately, this requires circuit traces to be cut to install switches to physically disconnect the signal from a device pin. Further, switches must be installed to physically short circuit two signals together from a set of device pins. Frequently, slot extender boards must also be used physically to install and operate the failable pack in the system. This may introduce different timing delays from normal system operation, which becomes unacceptable as hardware speed increases.

Accordingly, what is needed in the art is a new method that leverages the existing capabilities of the product hardware without the need to physically modify the system circuit board.

### SUMMARY OF THE INVENTION

To address the above-discussed deficiencies of the prior art, the present invention provides a system for, and method of, emulating hardware failures and a Joint Test Action Group (JTAG) (IEEE Std. 1149.1 Boundary-Scan) test tool incorporating the same. In one embodiment, the system includes: (1) a vector generator configured to generate at least one device failure emulation vector and (2) a JTAG interface associable with the vector generator and configured to deliver the device failure emulation vector to hardware thereby to test system software associated with the hardware.

The present invention introduces a new and unexpected use for an existing test method: a way of using JTAG vectors to emulate hardware failures not to test the hardware, but instead to test associated system software. More specifically, IEEE Standard 1149.1-2001 IEEE Standard Test Access Port and Boundary-Scan Architecture (1149.1) test patterns can now be used selectively to engage HIGHZ or EXTEST mechanisms in a device to deterministically emulate the asynchronous failure of that device with respect to the system up time without the need to physically modify the system circuit board hardware.

In another aspect, the present invention provides a method of emulating hardware failures. In one embodiment, the method includes: (1) generating at least one device failure emulation vector and (2) delivering the device failure emulation vector to hardware thereby to test system software associated with the hardware.

In yet another aspect, the present invention provides a JTAG test tool. In one embodiment, the test tool includes: (1) a vector database configured to contain vector segments corresponding to devices in hardware and (2) a vector generator associated with the vector database and configured to employ ones of the vector segments to generate at least one device failure emulation vector, the at least one device failure emulation vector deliverable to hardware thereby to test system software associated with the hardware.

The foregoing has outlined, rather broadly, preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention in its broadest form.

### BRIEF DESCRIPTION OF THE DRAWINGS

For a more complete understanding of the present invention, reference is now made to the following descriptions taken in conjunction with the accompanying drawings, in which:

FIG. 1 illustrates a block diagram of one embodiment of a combination system containing both system software and hardware with which a test system constructed according to the principles of the present invention can advantageously operate;

FIG. 2 illustrates a block diagram of the combination and test systems of FIG. 1 showing the hardware portion of the combination system in greater detail;

FIG. 3 illustrates a block diagram of the combination and test systems of FIG. 1 showing one embodiment of the test system in greater detail;

FIG. 4 illustrates a flow diagram of one embodiment of. a method of generating a device failure emulation vector employable when a HIGHZ instruction is available and carried out according to the principles of the present invention;

FIG. 5 illustrates a flow diagram of one embodiment of a method of generating a device failure emulation vector based on an EXTEST instruction, using BDSL Safe Values and carried out according to the principles of the present invention; and

FIGS. 6A and 6B together illustrate a flow diagram of one embodiment of a method of generating a device failure emulation vector based on an EXTEST instruction, using SAMPLED data and carried out according to the principles of the present invention.

### DETAILED DESCRIPTION

Most designs of “highly available systems” use complex devices that incorporate the well-known IEEE Standard 1149.1-2001 IEEE Standard Test Access Port and Boundary-Scan Architecture (1149.1), also called Joint Test Action Group, or JTAG, to assist in testing during manufacturing of hardware. Many of the less complex devices used in this hardware also incorporate the use of 1149.1 technology further to support testing during manufacturing of the hardware.

JTAG was developed exclusively to test hardware. JTAG tests hardware by allowing inputs to be provided to the hardware and the outputs of the hardware to be analyzed. The present invention, however, uses JTAG in a new, unanticipated and nonobvious way: to emulate hardware failures for the purpose of testing the system software that controls the hardware. The hardware is therefore not the subject of the test; the system software is instead.

Described herein are various methods for automatically generating the appropriate boundary-scan patterns required to cause a logic cluster or boundary scan device to go into an appropriate disabled state and thereby emulate a failure to which the system software is tasked to respond in a timely and appropriate manner. Fundamentally, boundary-scan IEEE Standard 1149.1 is used to asynchronously disable the device. No modification to functional hardware (e.g., circuit boards) is required to use these methods of emulating a device failure. The device remains in a functional mode until disabled by included boundary-scan instructions. System software initialization and operation are not affected until the boundary-scan instruction is applied. The system software may generate the needed vector(s). The boundary-scan instruction may be issued using an externally connected test system independent of the system software. The boundary-scan instructions may be issued to the device asynchronously and independent of the system software state. Data to trigger HIGHZ or EXTEST instructions may be automatically generated using a system software model of the boundary-scan circuit. To use the IEEE Standard 1149.1 technology to perform the emulation of a device failure, 1149.1 vector patterns ought to be applied to the device to select the HIGHZ instruction in the device or to preload the device with a safe set of output patterns that will not harm the circuit when applied using the EXTEST instruction. This could be done my manually calculating the required pattern for the hardware being tested and manually generating the vector pattern for the targeted device failure emulation or the vectors could be automatically generated using a system software model of the hardware. Described herein are various methods for automatically generating the device failure emulation patterns for each failable device on the hardware with the boundary-scan capability.

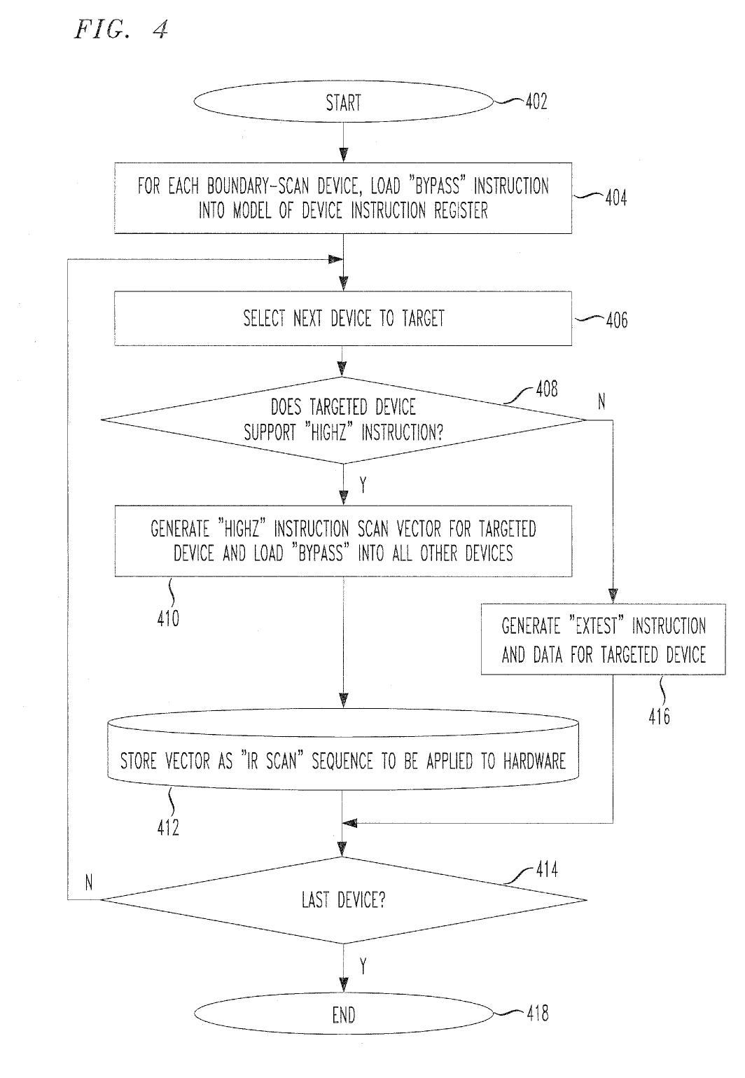

The illustrated embodiment of the method to automatically generate the device failure emulation patterns for each failable device calls for each device to be modeled based on the IEEE Standard 1149.1b-1994 Supplement to IEEE Standard 1149.1-1990, IEEE Standard Test Access Port and Boundary-Scan Architecture Boundary-Scan Description Language (BSDL) or derivations from such. The modeled devices are then ordered based on the organization of the boundary-scan chain in the hardware design (e.g., TDO to TDI daisy chain ordering). If the targeted device supports the optional HIGHZ instruction, a method as shown in FIG. 4 may be employed.

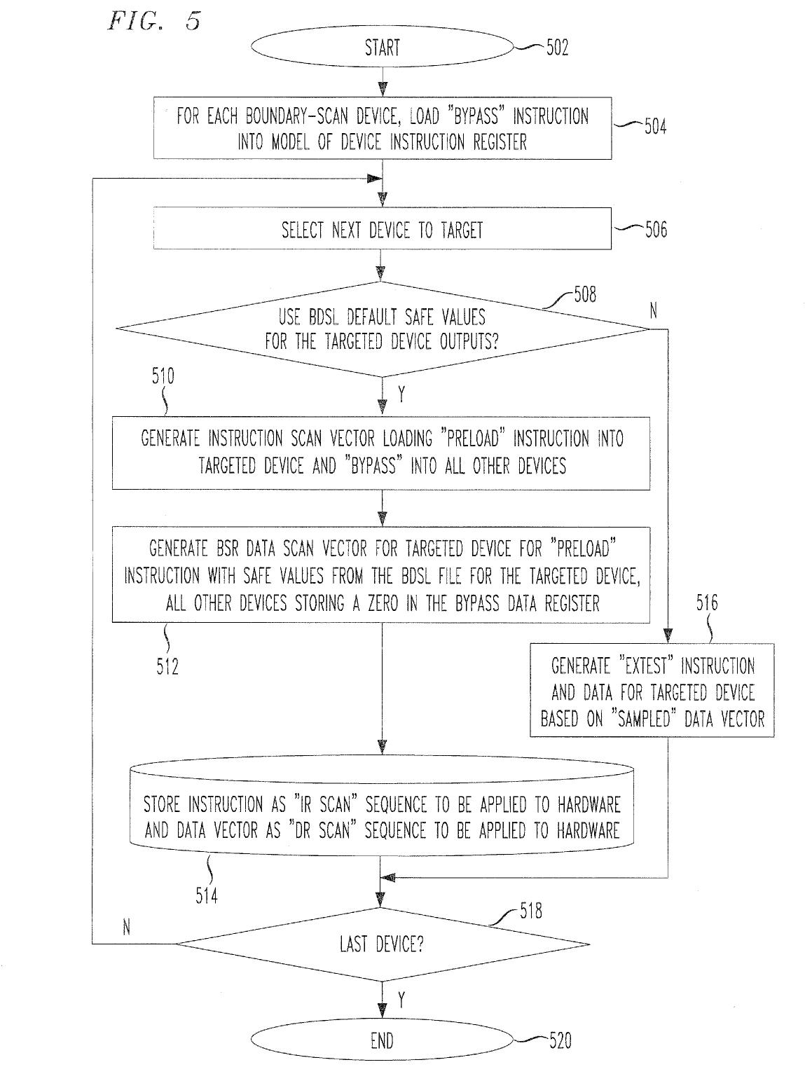

If the targeted device does not support the optional HIGHZ instruction two illustrated methods may be used to generate the boundary-scan vector to disable the device. The first illustrated method involves using the defined safe values from the BSDL information directly and applying them to the outputs of the device assuming these safe values are indeed safe for the targeted hardware design. Typically, these safe values are applied to a control cell for a device's input pin that forces the pin to an input state. In other cases the output is forced to a strong-0, strong-1, weak-0, or weak-1 output state by applying a value to a control cell for a device's output pin if one is available. An exemplary method for generating the boundary-scan vectors based on the BSDL safe values is described in FIG. 5.

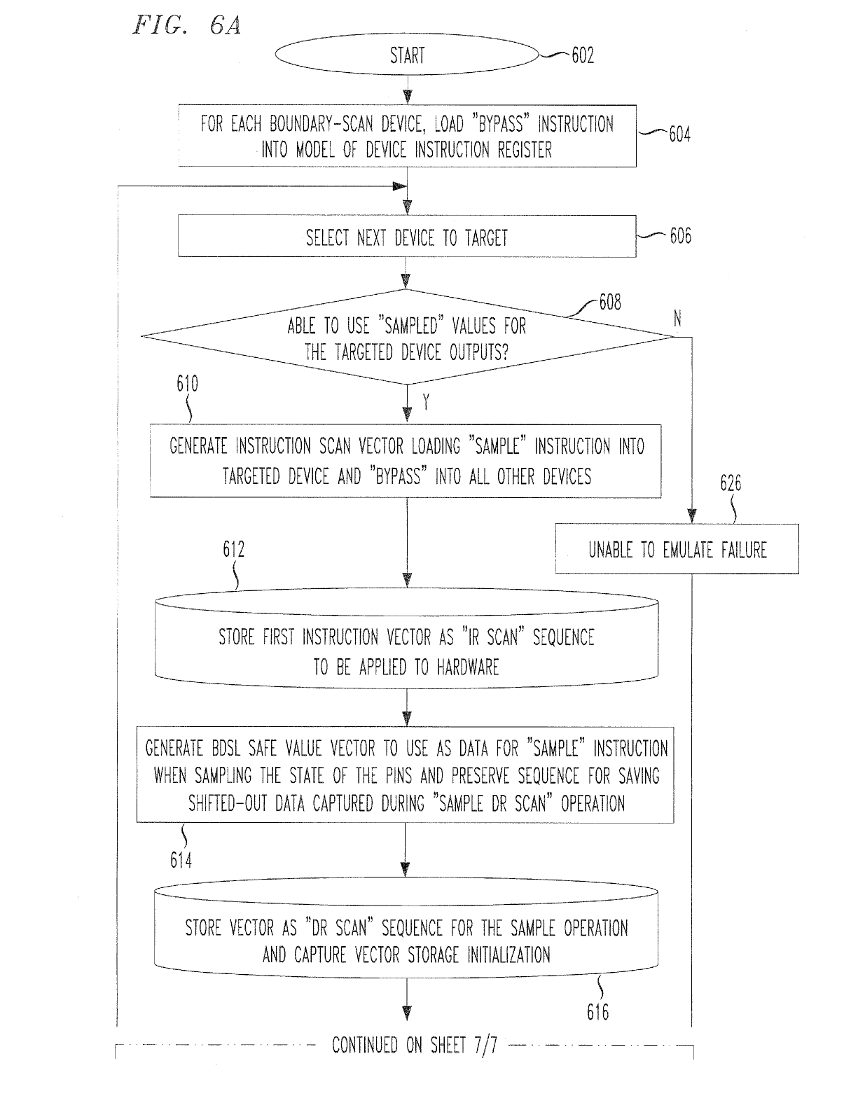

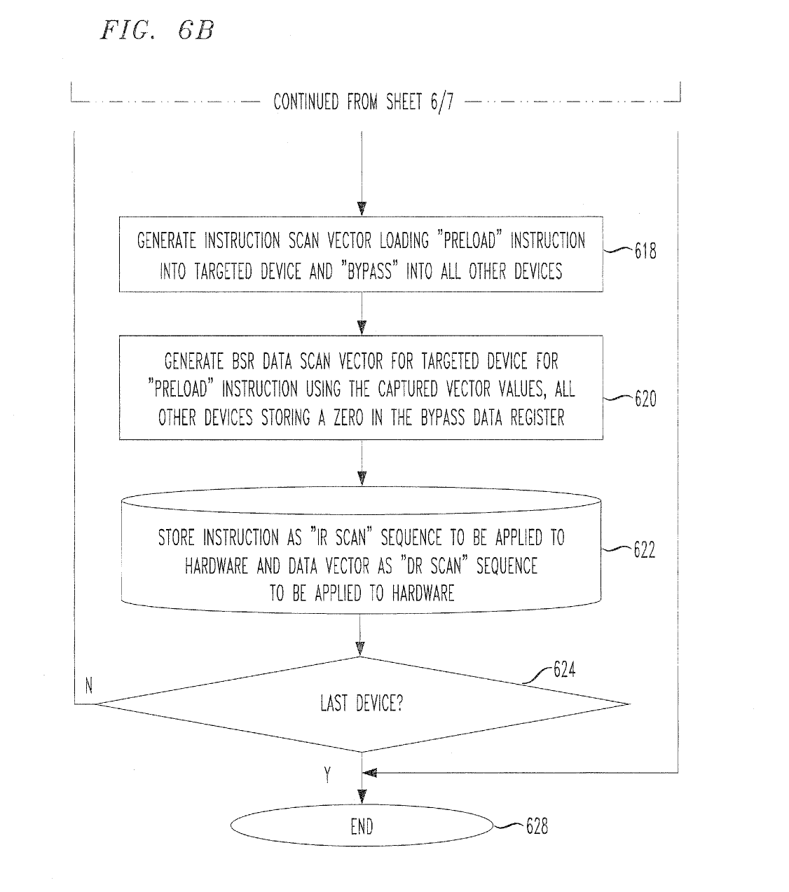

If the targeted device does not support the optional HIGHZ instruction and the BSDL safe values are not usable, a third illustrated method for disabling the device may be used. This method performs an 1149.1 SAMPLE operation of the device to get a snap shot of the current state of the output pins when the device is functioning. This state is then captured and preserved to be preloaded into the device as the disable state by emulating a stuck-at condition. In most cases, this vector may be used to inject failures into the system without damaging the device or surrounding circuits since this pattern has already been applied to the hardware and is now no longer changing with changes to the inputs of the targeted failing device. However, this method is the least favored method since the assumption is that the device outputs must change for normal operation. For some sequential logic designs, this is not true. A method for generating the boundary-scan vectors based on sampling the outputs is described in FIGS. 6A and 6B. Not all serial vector languages used to apply boundary-scan vectors supports this method of operation. The Serial Vector Format (SVF) will not support this method directly. However, the well-known EIA/JESD71 Standard Test and Programming Language (STAPL) format is able to support such a method of operation, since it is able to preserve the scanned out vector in a language-dependent bit vector array element.

One skilled in the boundary scan technology may be capable of generating such vectors by hand using STAPL or some other such dynamic vector language, but the more complex the circuit design the more difficult it is to produce an accurate scan vector. Thus, the exemplary method illustrated herein is able accurately and automatically to generate the vector information necessary to perform System software Verification testing by temporarily disabling a targeted device and observing whether the System software was able to detect the failure.

The present invention potentially, but not necessarily, offers some or all of the following advantages. First, features required to use the boundary-scan method are generally already available in most hardware, since the use of JTAG is required to test most hardware built due to its complexity and lack of physical test point access. Second, no modifications are required to the hardware to provide system software test capability. Thus, the reliability of the hardware is not compromised. Third, the hardware failure emulation vectors necessary to cause emulated device failure are able to be automatically generated from computer-aided design (CAD) information about the board and devices. Fourth, it is possible to modify the illustrated methods to produce more than one device failure emulation for a given combination system. Fifth, the test may be applied to the system without any modification to the existing system software. Sixth, the tests may be applied to the system asynchronously independent to the state of the system software. Seventh, the tests may be applied to the system using a simple personal computer (PC)-based test tool or using a system level diagnostic board.

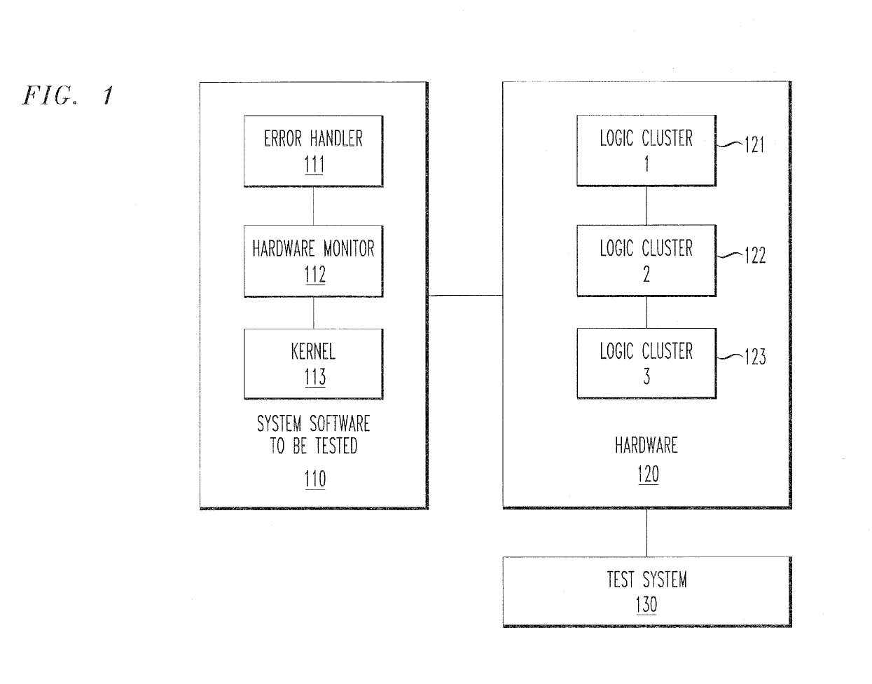

Referring initially to FIG. 1, illustrated is a block diagram of one embodiment of a combination system containing both system software and hardware with which a test system constructed according to the principles of the present invention can advantageously operate. The combination system may perform any function whatsoever. One example set forth above is an ATM switch, but examples can be readily found in almost every technological field.

The illustrated exemplary system is intended to be extremely generic and includes system software to be tested 110 (sometimes called “system software” herein) and hardware 120. The system software to be tested 110 is responsible for controlling the operation of the hardware 120. The system software includes an error handler 111, a hardware monitor 112 and a kernel 113. The hardware monitor 112 monitors the hardware to determine whether or not it is functioning properly. If the hardware monitor 112 determines that the hardware is not functioning properly, the error handler 111 is responsible for diagnosing the malfunction and taking such steps as may be necessary to maintain system operation in light of the malfunction. The kernel 113 contains core functions of the system software to be tested 110 and therefore typically resides in main memory as the system software to be tested 110 executes. Because the system software to be tested 110 is intended to be generic, it can perform any function whatsoever with respect to the hardware 120, subject only to the requirements or objectives of a particular application.

The hardware 120 may take the form of one or more circuit boards configured to hold logic clusters that may take the form of integrated circuits. The hardware 120 is illustrated as including first, second and third logic clusters, designated logic cluster 1 121, logic cluster 2 122 and logic cluster 3 123, respectively. The logic cluster 1 121, the logic cluster 2 122 and the logic cluster 3 123 are illustrated as being interconnected so as to cooperate with one another to perform one or more functions under the direct or indirect control of the system software to be tested 110. Because the hardware 120 is intended to be generic, it can perform any function whatsoever, subject only to the requirements or objectives of a particular application.

Because it is desired to test the system software to be tested 110, a test system 130 is coupled to the hardware 120. As will be shown in greater detail below, the test system 130 is configured to generate one or more “device failure emulation vectors” that are provided to the hardware 120 via a JTAG port (not shown in FIG. 1, but associated with the hardware 120). The device failure emulation vector(s) cooperate with boundary scan circuitry associated with the logic cluster 1 121, the logic cluster 2 122 and the logic cluster 3 123 to emulate a hardware failure of the logic cluster 1 121, the logic cluster 2 122 or the logic cluster 3 123 or any combination thereof and therefore challenge the system software to be tested 110 to detect and compensate for the emulated failure, preferably within a predetermined time limit. Logic clusters that have associated boundary scan circuitry may sometimes be called “boundary scan devices” herein.

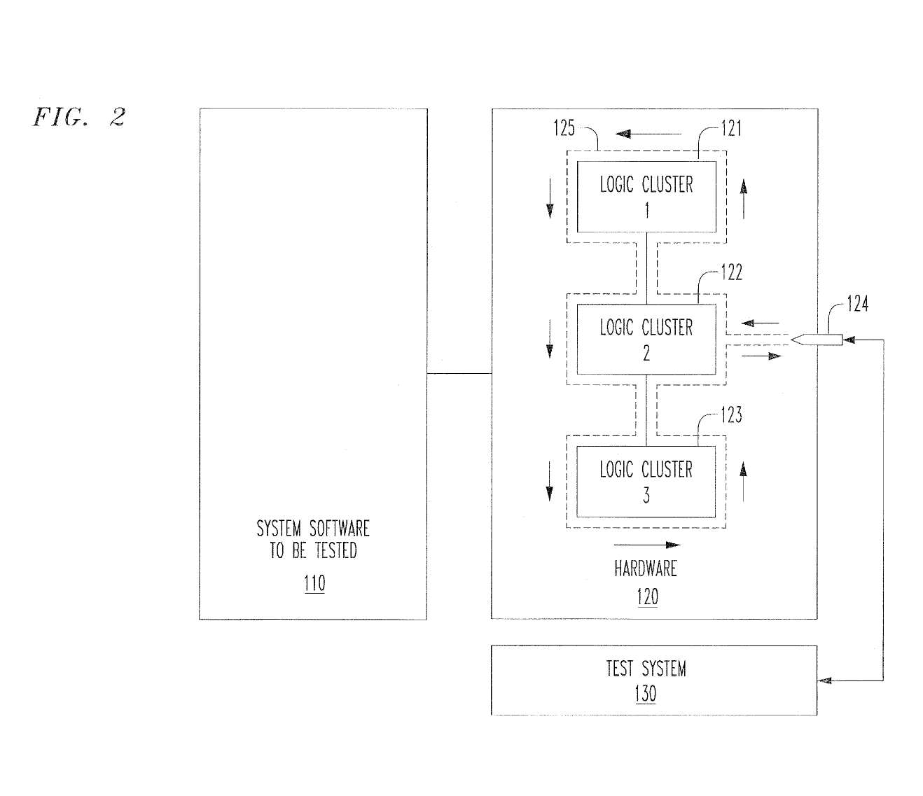

Having described the combination system in a general way, attention will now be paid to the manner in which JTAG may be implemented with respect to the hardware 120. Accordingly, turning now to FIG. 2, illustrated is a block diagram of the combination and test systems of FIG. 1 showing the hardware portion of the combination system in greater detail. FIG. 2 illustrates most of the elements of FIG. 1, but emphasizes the hardware 120. Illustrated are the logic cluster 1 121, the logic cluster 2 122 and the logic cluster 3 123. Although not shown in FIG. 2, each of the logic clusters 121, 122, 123 has a plurality of surrounding terminals or pins that allow the logic clusters 121, 122, 123 to be coupled to one another or to other circuitry not shown.

Those skilled in the pertinent art are familiar with the theory underlying JTAG and its structure and operation. As is understood, JTAG is a boundary-scan testing architecture that associates single-bit registers with most, if not all, of the pins of each logic cluster (e.g., the logic cluster 1 121, the logic cluster 2 122 and the logic cluster 3 123) in a given piece of hardware (e.g., the hardware 120) . The registers may be written with data to cause the logic clusters to experience a certain test condition. Data may also be read from the registers to analyze the operation of the logic clusters. A device instruction register is associated with the logic clusters. A JTAG bus 125 serially couples the single-bit data registers and the device instruction register(s) together to form a shift register. Each device contains a serially grouped set of single-bit data registers representing the device pin values. This grouped set of registers is referred to as the Boundary-Scan Register (BSR). A JTAG port 124 provides access to the JTAG bus 125, which is represented in FIG. 2 as a broken line surrounding the logic cluster 1 121, the logic cluster 2 122 and the logic cluster 3 123. Arrows proximate the JTAG bus 125 indicate an exemplary direction in which data may be shifted through the JTAG port 124.

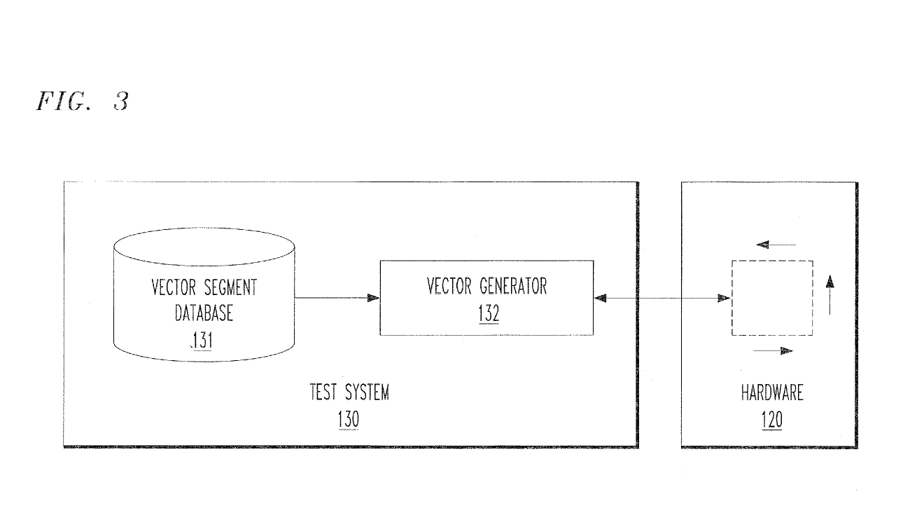

Having described an implementation of JTAG with respect to the hardware 120, an exemplary hardware failure emulation test system will now be described. Accordingly, turning now to FIG. 3, illustrated is a block diagram of the combination and test systems of FIG. 1 showing one embodiment of the test system in greater detail. The test system 130 interacts with the hardware 120, which is represented in FIG. 3 as generically containing a JTAG bus/shift register.

The illustrated embodiment of the test system 130 contains a vector segment database 131 and a vector generator 132. The vector generator 132 is configured to generate one or more device failure emulation vectors that, when provided to the hardware 120, cause the emulation of a hardware failure for the purpose of testing associated system software (not shown in FIG. 3). The vector generator 132 can generate the one or more device failure emulation vectors using various methods, of which three examples will be given below in conjunction with FIGS. 4, 5 and 6A and 6B.

In some exemplary methods, the vector generator 132 generates one or more device failure emulation vectors algorithmically. In other exemplary methods, the vector generator 132 generates one or more device failure emulation vectors by assembling vector segments retrieved from the vector segment database 131. In still other exemplary methods, the vector generator 132 generates one or more device failure emulation vectors based on data retrieved from the hardware 120 via the JTAG bus using the SAMPLE instruction. (The SAMPLE or PRELOAD instruction allows a snapshot of the normal operation of a component to be taken and examined. It also allows data values to be loaded onto the latched parallel outputs of the boundary-scan shift register prior to the selection of other boundary-scan test instructions.) In yet other exemplary methods, the vector generator 132 generates one or more device failure emulation vectors by means of a combination of algorithm, assembled vector segments and sampled data.

The test system 130 may be associated with the system software to be tested 110. However, care should be taken in doing so not to change the operating characteristics of the system software to be tested 110.

The test system 130 may advantageously take the form of a JTAG test tool or a portion thereof, embodied in software and executable in a general-purpose computer, such as a PC. Those skilled in the pertinent art understand that a JTAG test tool applies conventional test vectors to test devices in hardware. Those skilled in the art will understand, however, that a JTAG test tool can be readily modified to add the capability of generating device failure emulation vectors for testing system software as described herein. Furthermore, manufacturers of devices can supply corresponding vector segments that allow failure of those devices to be emulated for the purpose of testing system software. New JTAG test tools that generate device failure emulation vectors, conventional JTAG test tools modified to generate such vectors and the vector segments that can be combined to form such vectors all fall within the broad scope of the present invention.

Having generically described an exemplary test system, three exemplary methods for generating a device failure emulation vector will now be described. Accordingly, turning now to FIG. 4, illustrated is a flow diagram of one embodiment of a method of generating a device failure emulation vector employable when a HIGHZ instruction is available and carried out according to the principles of the present invention.

IEEE Standard 1149.1 provides an optional feature, through the HIGHZ instruction, that temporarily disables the outputs of a device and places the output into a high impedance state —effectively shutting down the device from its normal functional role without driving values on the outputs of the device. The IEEE Standard 1149.1-2001 standard states the purpose of the HIGHZ instruction, that is to place a given logic cluster, device or component in a state in which all of its system logic outputs are placed in an inactive drive state (e.g., high impedance). In this state, an in-circuit test system may drive signals onto the connections normally driven by a component output without incurring the risk of damage to the component. The present invention recognizes that this feature may be used, not for its intended design to aid in hardware testing, but to test system software. This optional feature may be used to disable a device asynchronously with respect to the system up time. Thus, a device failure may be emulated without modifying any hardware or damaging any devices in the hardware.

The method begins in a start step 402, wherein it is desired to generate a device failure emulation vector that takes advantage of an optional HIGHZ JTAG instruction when that instruction has been implemented in at least some of the logic clusters of a piece of hardware. In a step 404, for each boundary-scan device, a BYPASS instruction is loaded into a model of the hardware's JTAG device instruction register. (The BYPASS JTAG instruction allows rapid movement of data to and from other components on a board that are required to perform test operations.) In a step 406, the next device to target is selected.

In a decisional step 408, it is determined whether the targeted device supports the HIGHZ instruction. (Again, the HIGHZ instruction forces drivers associated with a target device into high impedance states.) If so, a step 410, a HIGHZ instruction scan vector is generated for the targeted device, and a BYPASS instruction is loaded into all other devices. If not, a step 416 is performed, in which an EXTEST instruction and data are generated for the targeted device. (The EXTEST instruction allows testing of off-chip circuitry and circuit board level interconnections.)

Assuming the targeted device supports the HIGHZ instruction and the step 410 was performed, the device failure emulation vector is stored as an IR SCAN vector to be applied to the hardware in a step 412. In a decisional step 414, it is determined whether the targeted device is the last device for which a hardware failure is to be emulated for the purpose of testing system software. If not, the method returns to the step 406. If so, the method proceeds to an end step 418, the device failure emulation vector having been generated.

If the optional HIGHZ instruction is not available in the device, the device failure can still be emulated using the. mandatory feature of EXTEST for IEEE Standard 1149.1. The EXTEST feature takes control of the device outputs and inputs using boundary-scan and drives or senses deterministic values from the device and to the device's internal logic. One skilled in the pertinent art can understand how EXTEST can effectively shut down a device from functioning normally.

Turning now to FIG. 5, illustrated is a flow diagram of one embodiment of a method of generating a device failure emulation vector based on an EXTEST instruction, using BDSL safe values and carried out according to the principles of the present invention.

The method begins in a start step 502. In a step 504, for each boundary-scan device, a BYPASS instruction is loaded into a model of the hardware's JTAG device instruction register. In a step 506, the next device to target is selected.

In a decisional step 508, it is determined whether BDSL default safe values can be used for the targeted device outputs. If so, in a step 510, a BSR instruction scan vector is generated by loading a PRELOAD instruction into the targeted device and a BYPASS instruction into all other devices. If not, in a step 516, an EXTEST instruction and data are generated for the targeted device based on a SAMPLED data vector.

Assuming BDSL default safe values can be used for the targeted device outputs and the step 510 was performed, a BSR data scan vector is generated for the targeted device for a PRELOAD instruction with safe values from the BDSL file for the targeted device, all other devices storing a zero in the bypass data register in a step 512. In a step 514, the instruction is stored as an IR SCAN vector to be applied to the hardware, and the data vector is stored as a DR SCAN vector to be applied to the hardware.

In a decisional step 518, it is determined whether the targeted device is the last device for which a hardware failure is to be emulated for the purpose of testing system software. If not, the method returns to the step 506. If so, the method proceeds to an end step 520, the device failure emulation vector having been generated.

Turning now to FIGS. 6A and 6B, illustrated is a flow diagram of one embodiment of a method of generating a device failure emulation vector based on an EXTEST instruction, using SAMPLED data and carried out according to the principles of the present invention.

The method begins in a start step 602. In a step 604, for each boundary-scan device, a BYPASS instruction is loaded into a model of the hardware's JTAG device instruction register. In a step 606, the next device to target is selected.

In a decisional step 608, it is determined whether or not SAMPLED values are able to be used for the targeted device outputs. If so, an instruction scan vector is generated by loading a SAMPLE instruction into the targeted device and a BYPASS instruction into all other devices in a step 610. If not, a hardware failure is unable to be emulated (in a step 626) and the method ends.

Assuming SAMPLED values can be used for the targeted device outputs and the step 610 was performed, the first instruction vector is stored as an IR SCAN vector to be applied to the hardware in a step 612. In a step 614, a BDSL safe value vector is generated. The BDSL safe value vector is used as data for the SAMPLE instruction when sampling the state of the pins and preserved for saving shifted-out data captured during a SAMPLE DR SCAN operation.

In a step 616, the resulting vector is stored as a DR SCAN vector for the sample operation, and the vector storage initialization is captured. In a step 618, an instruction scan vector is generated by loading a PRELOAD instruction into the targeted device and a BYPASS instruction into all other devices. In a step 620, a BSR data scan vector is generated for the targeted device for a PRELOAD instruction using the captured vector values. All other devices are provided a zero in their associated bypass data register. In a step 622, the resulting instruction vector is stored as an IR SCAN vector to be applied to the hardware. The resulting data vector is stored as a DR SCAN vector to be applied to the hardware.

In a decisional step 624, it is determined whether or not the target device is the last device. If not, the method returns to the step 606. If so, the method proceeds to an end step 628, the device failure emulation vector having been generated.

Although the present invention has been described in detail, those skilled in the art should understand that they can make various changes, substitutions and alterations herein without departing from the spirit and scope of the invention in its broadest form.

What is claimed is:

1. A system for emulating hardware failures, comprising:
a vector generator configured to generate at least one device failure emulation vector; and
a JTAG interface associable with said vector generator and configured to deliver said device failure emulation vector to hardware thereby to test system software associated with said hardware.

2. The system as recited in claim 1 further comprising a vector database, said vector generator being configured to generate said at least one device failure emulation vector by assembling vector segments retrieved from the vector segment database.

3. The system as recited in claim 1 wherein said vector generator generates said at least one device failure emulation vector based on data retrieved from said hardware.

4. The system as recited in claim 1 wherein said at least one device failure vector contains a HIGHZ instruction for a targeted device in said hardware and BYPASS instructions for other devices in said hardware.

5. The system as recited in claim 1 wherein said at least one device failure vector comprises:
an instruction scan vector containing a PRELOAD instruction for a targeted device in said hardware and BYPASS instructions for other devices in said hardware; and
a BSR data scan vector containing a PRELOAD instruction with safe values for said targeted device and zeroes for said other devices.

6. The system as recited in claim 1 wherein said at least one device failure vector comprises an EXTEST instruction and data for a targeted device in said hardware based on a SAMPLED data vector.

7. The system as recited in claim 1 wherein said at least one device failure vector comprises an instruction scan vector containing a SAMPLE instruction for a targeted device in said hardware and BYPASS instructions for other devices in said hardware.

8. A method of emulating hardware failures, comprising:
generating at least one device failure emulation vector; and
delivering said device failure emulation vector to hardware thereby to test system software associated with said hardware.

9. The method as recited in claim 8 further comprising a vector database, said generating comprising generating said at least one device failure emulation vector by assembling vector segments retrieved from the vector segment database.

10. The method as recited in claim 8 wherein said generating comprises generating said at least one device failure emulation vector based on data retrieved from said hardware.

11. The method as recited in claim 8 wherein said at least one device failure vector contains a HIGHZ instruction for a targeted device in said hardware and BYPASS instructions for other devices in said hardware.

12. The method as recited in claim 8 wherein said at least one device failure vector comprises:
an instruction scan vector containing a PRELOAD instruction for a targeted device in said hardware and BYPASS instructions for other devices in said hardware; and
a BSR data scan vector containing a PRELOAD instruction with safe values for said targeted device and zeroes for said other devices.

13. The method as recited in claim 8 wherein said at least one device failure vector comprises an EXTEST instruction and data for a targeted device in said hardware based on a SAMPLED data vector.

14. The method as recited in claim 8 wherein said at least one device failure vector comprises an instruction scan vector containing a SAMPLE instruction for a targeted device in said hardware and BYPASS instructions for other devices in said hardware.

15. A JTAG test tool, comprising:
a vector database configured to contain vector segments corresponding to devices in hardware; and
a vector generator associated with said vector database and configured to employ ones of said vector segments to generate at least one device failure emulation vector, said at least one device failure emulation vector deliverable to hardware thereby to test system software associated with said hardware.

16. The test tool as recited in claim 15 wherein said vector generator generates said at least one device failure emulation vector based on data retrieved from said hardware.

17. The test tool as recited in claim 15 wherein said at least one device failure vector contains a HIGHZ instruction for a targeted device in said hardware and BYPASS instructions for other devices in said hardware.

18. The test tool as recited in claim 15 wherein said at least one device failure vector comprises:
an instruction scan vector containing a PRELOAD instruction for a targeted device in said hardware and BYPASS instructions for other devices in said hardware; and
a BSR data scan vector containing a PRELOAD instruction with safe values for said targeted device and zeroes for said other devices.

19. The test tool as recited in claim 15 wherein said at least one device failure vector comprises an EXTEST instruction and data for a targeted device in said hardware based on a SAMPLED data vector.

20. The test tool as recited in claim 15 wherein said at least one device failure vector comprises an instruction scan vector containing a SAMPLE instruction for a targeted device in said hardware and BYPASS instructions for other devices in said hardware.
